(19) United States
(12) Patent Application Publication
(10) Pub. No.: US 2007/0001901 A1
(43) Pub. Date: Jan. 4, 2007

(54) STRUCTURE OF POSITIONING SYSTEM AND METHOD FOR POSITIONING THEREOF

(75) Inventors: Chun-Nan Yeh, Nantou County (TW); Chien-Yang Chang, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: MITAC INTERNATIONAL CORP., Taoyuan (TW)

(21) Appl. No.: 11/428,549

(22) Filed: Jul. 4, 2006

(30) Foreign Application Priority Data
Jul. 4, 2005 (TW) 94122512

(51) Int. Cl. G01S 5/14; H04Q 7/20

(52) U.S. Cl. 342/357.09; 342/357.15; 455/466

(57) ABSTRACT

A positioning method, adapted for a cellular mobile device, includes the steps of: a first user terminal obtaining positioning data required for positioning; the first user terminal sending a short message to transmit the positioning data to a second user terminal; writing the positioning data into the second user terminal, by which the second user terminal can process positioning.

### CROSS-REFERENCE TO RELATED APPLICATION

This application claims the priority benefit of Taiwan application serial no. 94122512, filed Jul. 4, 2005. All disclosure of the Taiwan application is incorporated herein by reference.

### BACKGROUND OF THE INVENTION

1. Field of Invention

The present invention relates to a positioning method, and particularly to a positioning method for a Global Positioning System (GPS) which can reduce the first positioning time.

2. Description of Related Art

GPS that can provide precision positions, velocities and times for users is a navigation system combining satellite and wireless technologies together and being adapted for navigation positioning. The GPS developing plan is conducted by U.S. department of defense and assisted with U.S. department of transportation. The GPS technology was later transmitted for public using in fields of navigation positioning, precision measurement, standard timing. Cooperating with communication technology and accompanying with the development of satellite technology, GPS technology is widely used in current life application and is rapidly developing.

A GPS generally includes three parts, in space satellites, ground controllers and user receivers. What can be public approached and owned is the third part in user receivers. A GPS receiver, receiving the signals sent from a synchronized satellite group consisting of 24 satellites being disposed at space 20,200 km from the ground, measures distance according to the timing difference of wireless signal being traveled in space base. The synchronized satellites emit wireless information including position and time related information of the satellites, while a GPS receiver receives the information and calculates the information to obtain the user-needed data of positions, velocities and times. The position of each satellite can be obtained via the ephemeris data of the satellite. The receiver can be positioned by the distances from the receiver respectively to at least three satellites.

The time of the GPS receiver receiving GPS satellite signals for determining an initial position is called a time to first fix (TTFF), is also referred as a coldstart stage. The TTFF lasts relatively long because the GPS receiver has to receive ephemeris data, according to which the receiver can then find out four positioning satellites being at best communicating status with the receiver. Generally, the TTFF of a GPS receiver is about 60 seconds. This is a comparatively long time to most of users.

### SUMMARY OF THE INVENTION

An object of the invention is to provide a positioning system structure and a positioning method thereof for reducing the TTFF and therefore rapidly positioning the initial position of the receiver.

The invention provides a positioning system structure and a positioning method thereof comprising: a first user terminal obtaining a positioning data required for positioning. A short message having the positioning data is sent from the first user terminal to a second user terminal. The positioning data is written into the second user terminal, by which the second user terminal can process positioning.

According to an embodiment of the invention, the process of writing the positioning data to the second user terminal includes the steps of: starting an application program in response to the short message and receiving the positioning data; analyzing the received positioning data with the application program; writing the analyzed positioning data into the second user terminal.

According to an embodiment of the invention, the process of the first user terminal obtaining the positioning data includes the step of directly downloading the positioning data from a plurality of GPS satellites. According to another embodiment of the invention, the process of the first user terminal obtaining the positioning data includes the steps of: transmitting an identification address from the first user terminal to a wireless communication station, for example Global System for Mobile communication (GSM) station. Then, from the wireless communication station, the first user terminal receives an assistant positioning data including the ephemeris data and the angles of azimuth and elevation of the GPS satellites. Then, the first user terminal obtains the positioning data from the assistant positioning data.

According to an aspect of the embodiment, the present invention provides a positioning system structure, including a first user terminal and a second user terminal, wherein the first user terminal has the positioning data required for positioning the current position; the second user terminal can obtain the positioning data obtained by the first user terminal via a short message sent by the first user terminal and the second user terminal can thereby position the current position according to the short message. Further, for example, the positioning data from the first user terminal is obtained from a Global System for Mobile communication (GSM) station.

According to the above, the second user terminal can shorten the TTFF by having the first user terminal obtaining the positioning data required for positioning, then sharing the positioning data from the first user terminal with the second user terminal, whereby the second user terminal can rapidly position the current position. In this manner, the second user terminal can reduce the time for the first positioning.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic structural diagram for illustrating a positioning system according to an embodiment of the invention.

FIG. 2 is a flowchart of a positioning method according to an embodiment of the invention.

FIG. 3 is flowchart for illustrating the process of a first user terminal transmitting the positioning data from a first user terminal to a second user terminal via a short message, according to an embodiment of the invention.

FIG. 4 is a flowchart for illustrating the process of obtaining the positioning data in a first user terminal.

FIG. 5 is a schematic structural diagram for illustrating a positioning system according to another embodiment of the invention.

### DESCRIPTION OF THE PREFERRED EMBODIMENTS

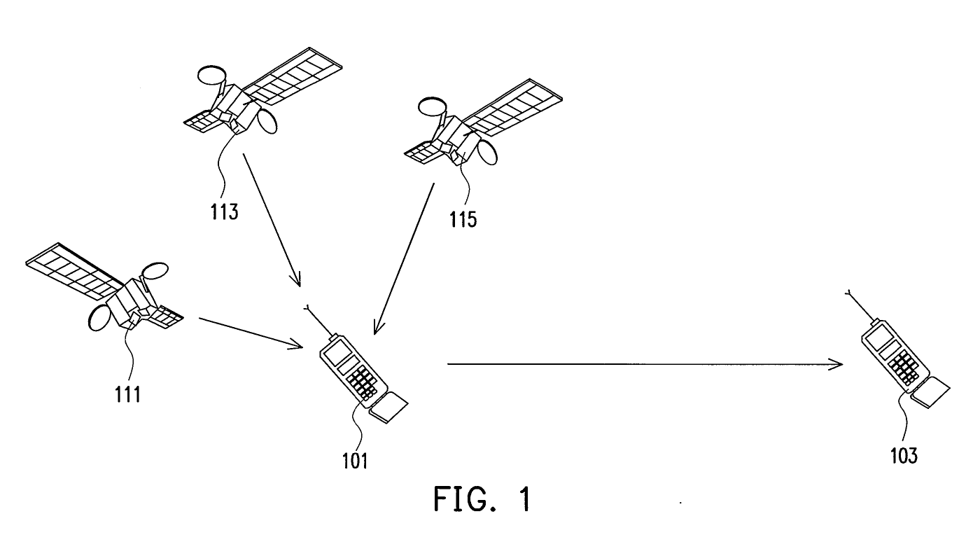

FIG. 1 is a schematic structural diagram for illustrating a positioning system according to an embodiment of the invention. Referring to FIG. 1, a positioning system structure provided by the present invention includes a first user terminal 101 and at least a second user terminal 103, the first user terminal 101 already having the positioning data required for positioning current position. When the second user terminal is intended to position the current position, the first user terminal 101 can transmit the positioning data to the second user terminal 103 for sharing the positioning data via a wireless transmitting system. And then the second user terminal 103 can directly use the positioning data obtained from the first user terminal for positioning, thus the TTFF of the second user terminal spending on searching for satellite signals is shorten.

According to an embodiment of the invention, the first user terminal 101 and the second user terminal 103 for example are mobile devices having positioning modules, wherein the positioning modules can be GPS modules, and the mobile devices can be mobile phones, personal digital assistant (PDA), or portable navigation device.

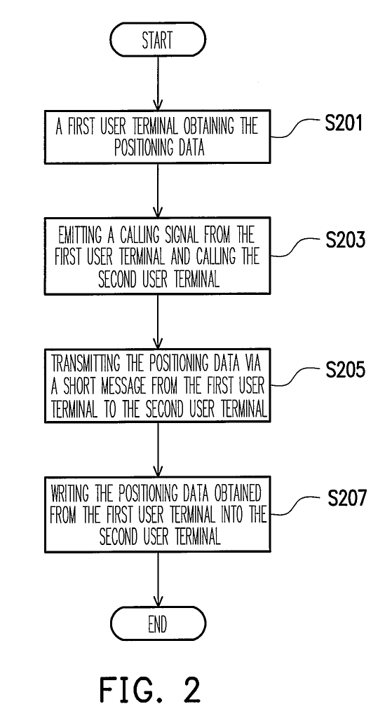

FIG. 2 is a flowchart of a positioning method according to an embodiment of the invention. Referring to FIG. 1 and FIG. 2 together, when the user of the first user terminal 101 intends to position the current position, a step S201 for obtaining the positioning data required for positioning should be processed. The steps about the first user terminal 101 for obtaining the positioning data are to be illustrated later.

After the first user terminal 101 obtaining the positioning data, if a second user terminal 103 intends to position the current position as well, the steps are as following. Firstly, the first user terminal 101 in step S203 emits calling signals to call the second user terminal 103; then in step S205, the positioning data is transmitted to the second user terminal 103; then in step S207, the positioning data obtained from the first user terminal 101 is written into a positioning module of the second user terminal 103 for the second user terminal to position the current position.

Generally, the aforementioned positioning data includes for example the ephemeris data of the GPS satellites 111, 113 and 115, and the ephemeris data includes the information of orbit position and group of each of the GPS satellites.

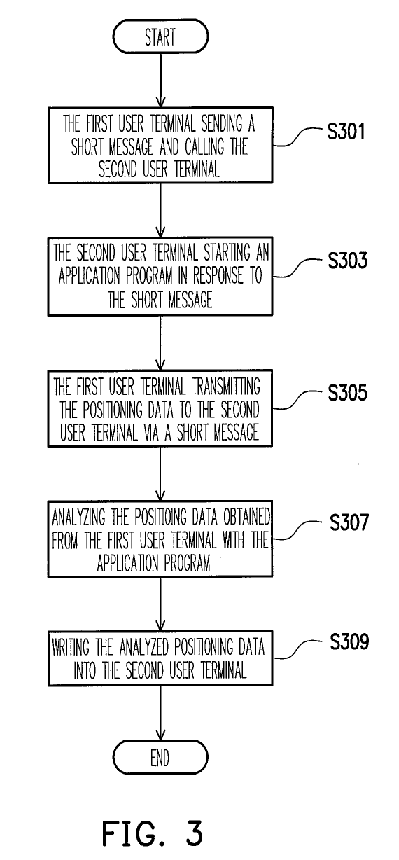

FIG. 3 is flowchart for illustrating the process of transmitting the positioning data from a first user terminal to a second user terminal via a wireless transmitting system, according to the an embodiment of the invention. The process is adapted for steps S203 and S205. Referring to FIG. 3, according to an embodiment of the invention, the wireless transmitting system for example can be a Short Message Service (SMS) for transmitting the positioning data.

According to the embodiment, when the first user terminal 101 is to transmit the positioning data to the second user terminal 103 for sharing the positioning data, the steps are as following. In step S301, the first user terminal 101 emits a short message and calls the second user terminal 103. Then, in step S303, the second user terminal 103 starts an application program in response to the short message emitted by the first user terminal 101. In step S305, the first user terminal 101 transmits the positioning data to the second user terminal, by for example an infrared manner.

After the positioning data being transmitted from the first user terminal 101 to the second user terminal 103, in step S307, the second user terminal 103 analyzes the positioning data transmitted from the first user terminal 101 with the foregoing application program. Then in step S309, the analyzed positioning data is written into a positioning module of the second user terminal 103.

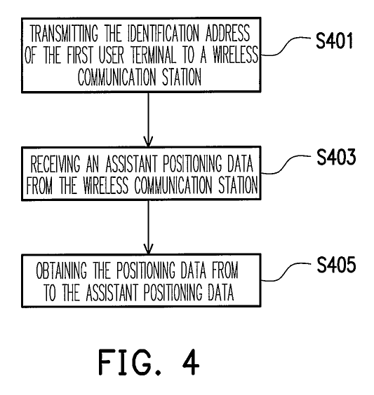

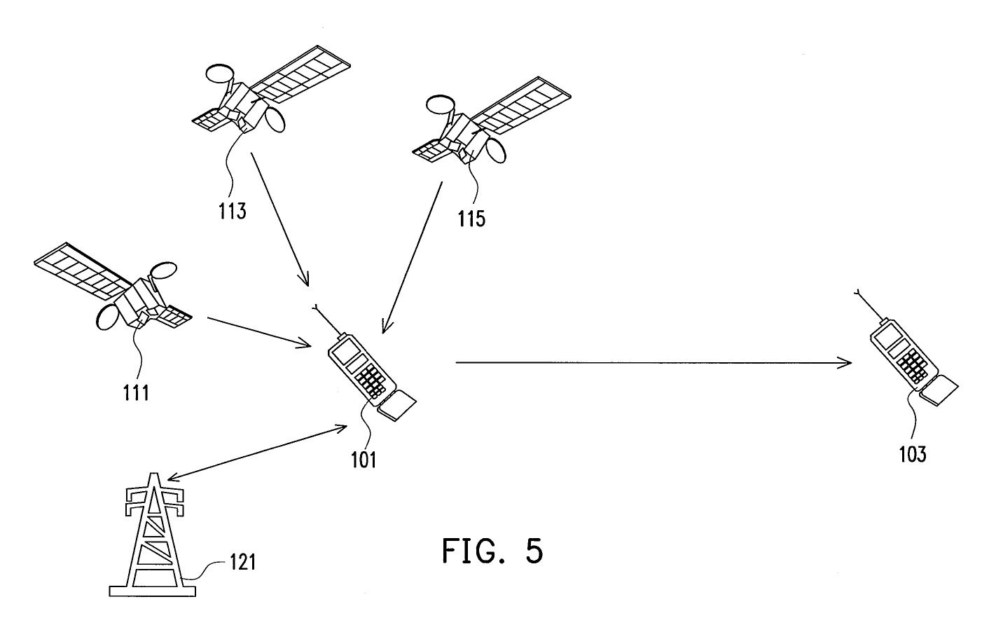

FIG. 4 is a flowchart for illustrating the process of obtaining the positioning data in a first user terminal. FIG. 5 is a schematic structural diagram for illustrating a positioning system according to another embodiment of the invention. In step S201 according to FIG. 2, in addition to downloading from the GPS satellites 111, 113 and 115, the first user terminal 101 can also obtain the positioning data with a process as shown in FIG. 4.

Referring to FIG. 4 and FIG. 5 together, to obtain the positioning data required for positioning, the first user terminal 101 in step S401 transmits an identification address of the first user terminal 101 to a wireless communication station 121. According to an aspect of the embodiment, the wireless communication station can be a GSM communication mobile phone station. Herein, in step S403, the wireless communication station 121 sends an assistant positioning data to the first user terminal 101, and the assistant positioning data includes the ephemeris data and the angles of azimuth and elevation of the GPS satellites. Then in step S405, the first user terminal 101 can rapidly obtain the positions of the GPS satellites 111, 113 and 115 from the assistant positioning data.

Other modifications and adaptations of the above-described preferred embodiments of the present invention may be made to meet particular requirements. This disclosure is intended to exemplify the invention without limiting its scope. All modifications that incorporate the invention disclosed in the preferred embodiment are to be construed as coming within the scope of the appended claims or the range of equivalents to which the claims are entitled.

What is claimed is:

1. A positioning method, adapted for a mobile device, comprising the steps of:
obtaining a positioning data required for positioning via a first user terminal;
sending a short message comprising the positioning data from the first user terminal to a second user terminal;
receiving the short message by the second user terminal; and
writing the positioning data into the second user terminal, whereby the second user terminal performing positioning.

2. The positioning method according to claim 1, wherein the step of writing the positioning data into the second user terminal comprises:
starting an application program in response to the short message and the application program receiving the positioning data; and
analyzing the received positioning data with the application program and writing the analyzed positioning data into the second user terminal.

3. The positioning method according to claim 1, wherein the step of obtaining the positioning data required for positioning via the first user terminal comprises directly downloading the positioning data from a plurality of GPS satellites.

4. The positioning method according to claim 1, wherein the step of obtaining the positioning data required for positioning from the first user terminal comprises:
transmitting an identification address of the first user terminal from the first user terminal to a wireless communication station;
receiving an assistant positioning data from the wireless communication station; and
obtaining the positioning data from the assistant positioning data.

5. The positioning method according to claim 4, wherein the wireless communication station is a Global System for Mobile communication (GSM) station.

6. The positioning method according to claim 4, wherein the assistant positioning data comprises ephemeris data and angles of azimuth and elevation of a plurality of GPS satellites.

7. The positioning method according to claim 1, wherein the first user terminal and the second user terminal comprise a mobile device having a GPS module.

8. The positioning method according to claim 1, wherein the positioning data comprises ephemeris data of a plurality of GPS satellites.

9. The positioning method according to claim 1, wherein the mobile device includes mobile phone, personal digital assistant, or portable navigation device.

10. A positioning system structure, comprising:
a first user terminal having a positioning data required for positioning a current position; and
a second user terminal, being adapted for obtaining the positioning data from the first user terminal via a short message, thereby the second user terminal positioning the current position according to the short message.

11. The positioning system structure according to claim 10, wherein the first user terminal and the second user terminal are mobile devices having a positioning module.

12. The positioning system structure according to claim 11, wherein the positioning module is a GPS module.

13. The positioning system structure according to claim 10, wherein the positioning data comprises ephemeris data of a plurality of GPS satellites.

14. The positioning system structure according to claim 11, wherein the positioning data from the first user terminal is obtained from a Global System for Mobile communication (GSM) station.

15. The positioning system structure according to claim 11, wherein the mobile devices include mobile phones, personal digital assistants, or portable navigation devices.
